(19) United States
(12) Patent Application Publication
(10) Pub. No.: US 2004/0232165 A1
(43) Pub. Date: Nov. 25, 2004

(54) Glue gun

(76) Inventor: Kuo-Jium Lee, Taichung (TW)

Correspondence Address: KUO-JIUM LEE, 58, MA YUAN WEST ST., TAICHUNG, TW

(21) Appl. No.: 10/444,723

(22) Filed: May 22, 2003

(51) Int. Cl. B67D 5/62

(52) U.S. Cl. 222/146.5

(57) ABSTRACT

A glue gun includes a gun body, and a heating device. The heating device includes a heating barrel mounted in the gun body and having an inner wall formed with a bore, and at least one heat conductive plate located in a middle portion of the bore of the heating barrel. Thus, the heat conductive plates are located in the middle portion of the bore of the heating barrel so as to heat and melt the glue stick from the middle portion to the periphery thereof, so that the glue stick is melted rapidly and evenly.

### BACKGROUND OF THE INVENTION

1. Field of the Invention

The present invention relates to a glue gun, and more particularly to a glue gun, wherein the heat conductive plates are located in the middle portion of the heating barrel, so that the glue stick is melted rapidly and evenly.

2. Description of the Related Art

A conventional glue gun in accordance with the prior art shown in FIG. 7 comprises a housing 50 having a rear end formed with a through hole 54 for passage of a glue stick 55 and having a lower end formed with a handle 51, a trigger 52 having a first end protruding outward from the handle 51 to be pressed by the user, a mediate portion provided with a spring 53 and a second end provided with a push portion 60, a heating barrel 56 mounted in the housing 50 and having a side formed with a receiving portion 57, a heat conductive plate mounted in the receiving portion 57 of the heating barrel 56, an ejection nozzle 59 screwed on a front end of the housing 50, and two conductive wires 58 each connected to the heat conductive plate. In operation, the glue stick 55 is extended through the through hole 54 of the housing 50 and is inserted into the heating barrel 56. Then, the trigger 52 is pressed to move the push portion 60 which pushes the glue stick 55 to move forward in the heating barrel 56, so that the glue stick 55 is heated by the heat conductive plate and is melted to form a liquid glue which is then ejected outward from the ejection nozzle 59 for use.

However, the heat conductive plate is located on one side of the heating barrel 56, so that the glue stick 55 cannot be melted evenly. In addition, the heat conductive plate is located on one side of the heating barrel 56, so that the glue stick 55 cannot be melted rapidly, thereby consuming time. Further, the heating barrel 56 has to additionally provide a receiving portion 57 to receive the heat conductive plate, thereby increasing costs of fabrication.

### SUMMARY OF THE INVENTION

The primary objective of the present invention is to provide a glue gun, wherein the heat conductive plates are located in the middle portion of the bore of the heating barrel so as to heat and melt the glue stick from the middle portion to the periphery thereof, so that the glue stick is melted rapidly and evenly.

Another objective of the present invention is to provide a glue gun, wherein the liquid glue is passed through the two sides of the heat conductive plates, so that the liquid glue is heated evenly and completely, thereby enhancing the effect of the liquid glue.

A further objective of the present invention is to provide a glue gun, wherein the heat conductive plates is directly received in the heating barrel without having to additionally provide a receiving portion to receive the heat conductive plates, thereby reducing costs of fabrication.

In accordance with the present invention, there is provided a glue gun, comprising:

a gun body; and

a heating device mounted in the gun body and including:

a heating barrel mounted in the gun body and having an inner wall formed with a bore; and

at least one heat conductive plate located in a middle portion of the bore of the heating barrel.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a glue gun in accordance with the preferred embodiment of the present invention;

FIG. 2 is a side plan cross-sectional assembly view of the glue gun as shown in FIG. 1;

FIG. 3 is a plan cross-sectional view of the glue gun as shown in FIG. 2;

FIG. 4 is a plan cross-sectional view of the glue gun as shown in FIG. 3;

FIG. 5 is a schematic operational view of the glue gun as shown in FIG. 3;

FIG. 6 is a schematic operational view of the glue gun as shown in FIG. 4; and

FIG. 7 is a side plan cross-sectional assembly view of a conventional glue gun in accordance with the prior art.

### DETAILED DESCRIPTION OF THE INVENTION

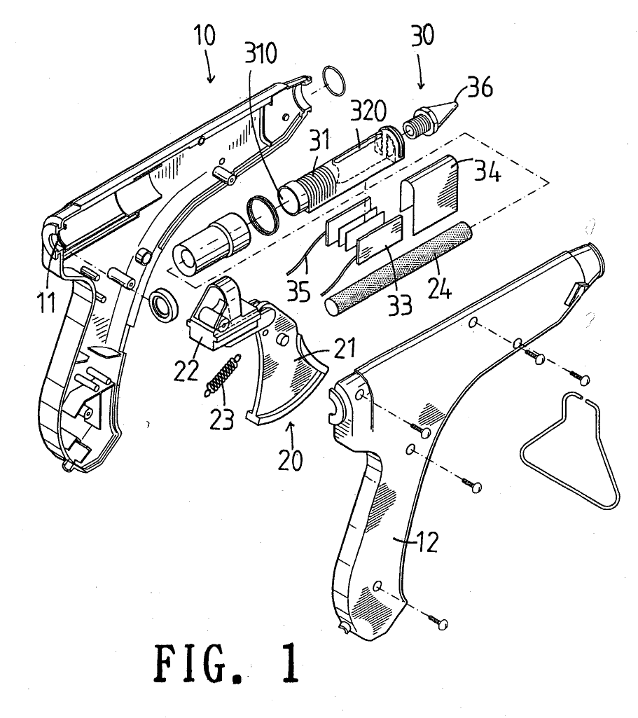

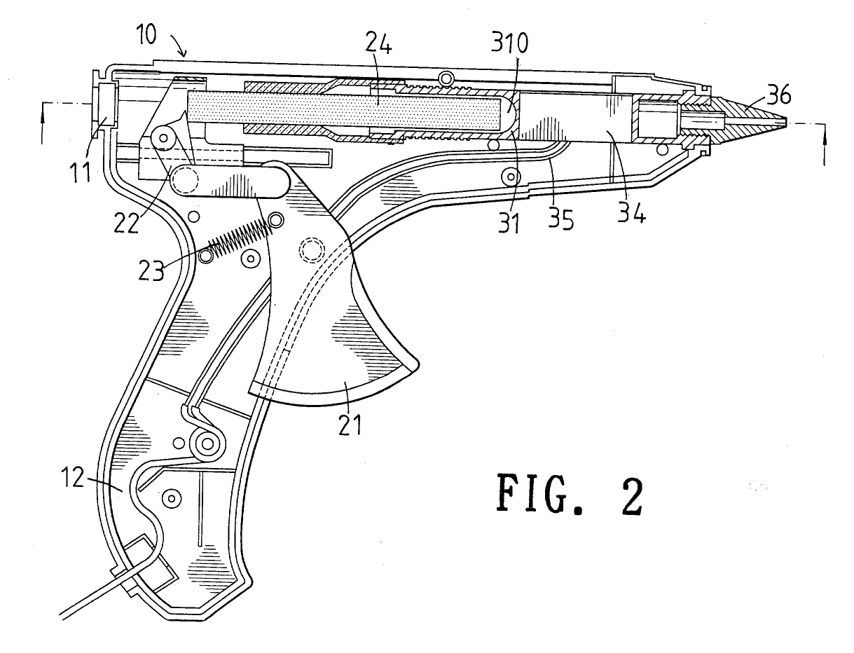

Referring to the drawings and initially to FIGS. 1 and 2, a glue gun in accordance with a first embodiment of the present invention comprises a gun body 10, a driving mechanism 20, and a heating device 30.

The gun body 10 has a rear end formed with a through hole 11 for passage of a glue stick 24. The gun body 10 has a lower end formed with a handle 12.

The driving mechanism 20 is mounted in the handle 12 of the gun body 10. The driving mechanism 20 includes a trigger 21 having a first end protruding outward from the handle 12 of the gun body 10 to be pressed by the user and a second end provided with a push portion 22. The trigger 21 of the driving mechanism 20 has a mediate portion provided with a spring 23.

The heating device 30 is mounted in the gun body 10. The heating device 30 includes a heating barrel 31, a plurality of heat conductive plates 33, and an ejection nozzle 36. The heating barrel 31 has an inner wall formed with a bore 310 and a partition 32 located in the bore 310. The partition 32 of the heating barrel 31 is longitudinally arranged in the bore 310. Preferably, the partition 32 of the heating barrel 31 is located in a middle portion of the bore 310 of the heating barrel 31. The heat conductive plates 33 are mounted in the partition 32 of the heating barrel 31. Preferably, the partition 32 of the heating barrel 31 is formed with a receiving space 320 to receive the heat conductive plates 33. The heating device 30 further includes an insulation body 34 coated on the heat conductive plates 33. The heating device 30 further includes two conductive wires 35 each having a first end connected to the heat conductive plates 33 and a second end extended outward from the gun body 10 and connected to an electric power supply (not shown). The ejection nozzle 36 is screwed on a front end of the gun body 10 and is connected to the bore 310 of the heating barrel 31.

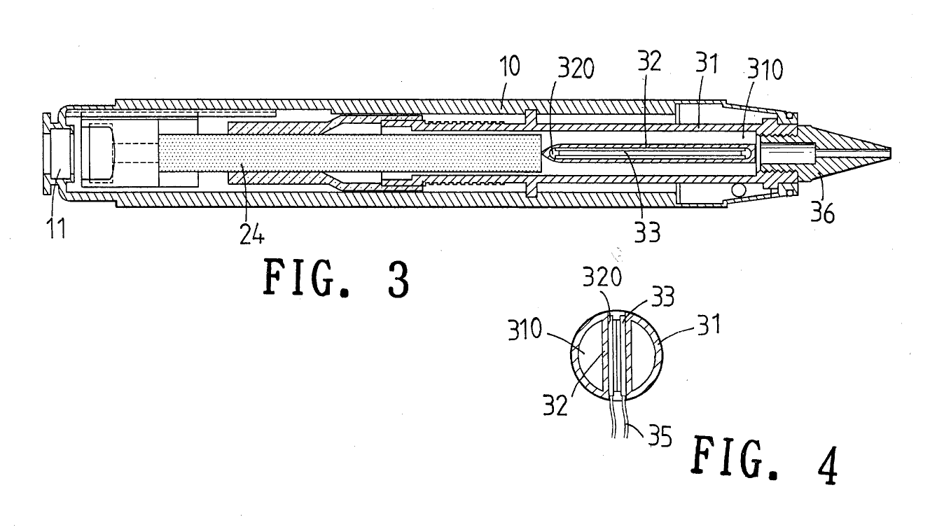

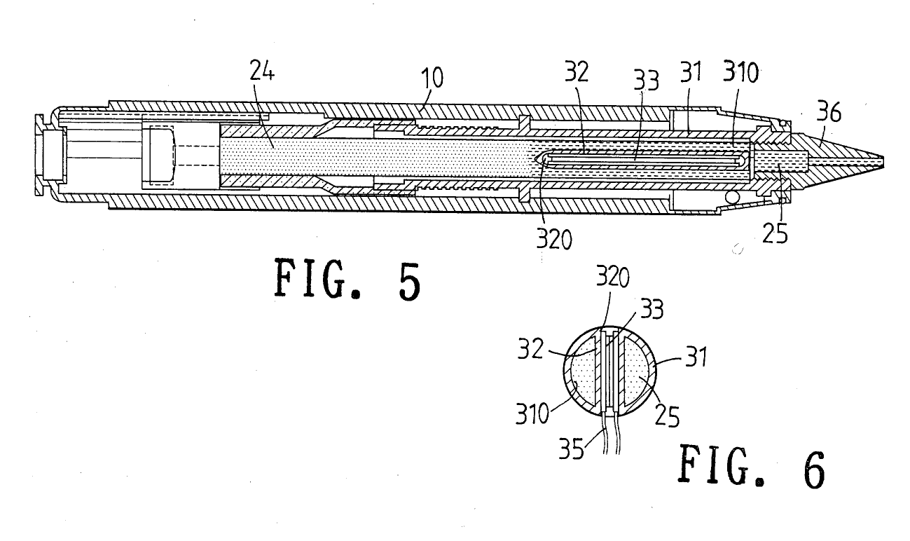

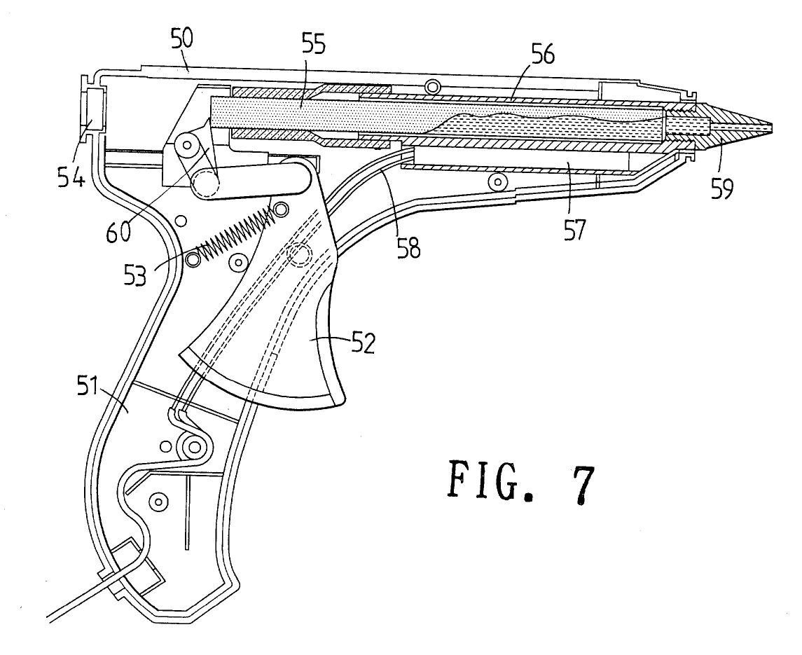

In operation, referring to FIGS. 3-6 with reference to FIGS. 1 and 2, the glue stick 24 is extended through the through hole 11 of the gun body 10 and is inserted into the bore 310 of the heating barrel 31. Then, the trigger 21 of the driving mechanism 20 is pressed to move the push portion 22 which pushes the glue stick 24 to move forward in the bore 310 of the heating barrel 31, so that the glue stick 24 is rested on the partition 32 of the heating barrel 31 and located beside the heat conductive plates 33 as shown in FIG. 3. At this time, the conductive wires 35 are energized to heat the heat conductive plates 33 which produce a heat energy to heat the glue stick 24 located beside the heat conductive plates 33, so that the glue stick 24 is melted to form an evenly distributed liquid glue 25 as shown in FIG. 5. Then, the liquid glue 25 is passed through the two sides of the heat conductive plates 33 and is ejected outward from the ejection nozzle 36 for use. In such a manner, the heat conductive plates 33 are located in the middle portion of the bore 310 of the heating barrel 31, so that the middle portion of the glue stick 24 is initially heated and the heat is gradually diffused outward from the middle portion of the glue stick 24 to the periphery of the glue stick 24 so as to heat and melt the glue stick 24 rapidly and evenly.

Accordingly, the heat conductive plates 33 are located in the middle portion of the bore 310 of the heating barrel 31 so as to heat and melt the glue stick 24 from the middle portion to the periphery thereof, so that the glue stick 24 is melted rapidly and evenly. In addition, the liquid glue 25 is passed through the two sides of the heat conductive plates 33, so that the liquid glue 25 is heated evenly and completely, thereby enhancing the effect of the liquid glue 25. Further, the heat conductive plates 33 is directly received in the heating barrel 31 without having to additionally provide a receiving portion to receive the heat conductive plates 33, thereby reducing costs of fabrication.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A glue gun, comprising:
a gun body; and
a heating device mounted in the gun body and including:
a heating barrel mounted in the gun body and having an inner wall formed with a bore; and
at least one heat conductive plate located in a middle portion of the bore of the heating barrel.

2. The glue gun in accordance with claim 1, wherein the inner wall of the heating barrel is formed with a partition located in the bore, and the heat conductive plate is mounted in the partition of the heating barrel.

3. The glue gun in accordance with claim 2, wherein the partition of the heating barrel is longitudinally arranged in the bore.

4. The glue gun in accordance with claim 2, wherein the partition of the heating barrel is located in the middle portion of the bore of the heating barrel.

5. The glue gun in accordance with claim 2, wherein the partition of the heating barrel is formed with a receiving space to receive the heat conductive plate.

6. The glue gun in accordance with claim 1, wherein the heating device further includes an ejection nozzle secured on a front end of the gun body and connected to the bore of the heating barrel.

7. The glue gun in accordance with claim 1, wherein the heating device further includes an insulation body coated on the heat conductive plate.

8. The glue gun in accordance with claim 1, wherein the heating device further includes two conductive wires each having a first end connected to the heat conductive plates and a second end extended outward from the gun body.

9. The glue gun in accordance with claim 1, wherein the gun body has a lower end formed with a handle, and the glue gun further comprises a driving mechanism mounted in the handle of the gun body and including a trigger having a first end protruding outward from the handle of the gun body and a second end provided with a push portion.
